(19) United States
(12) Patent Application Publication
(10) Pub. No.: US 2025/0238879 A1
(43) Pub. Date: Jul. 24, 2025

(54) USING CONFIDENCE SCORE TO MANAGE SLAS AND RATINGS OF ENERGY PROVIDERS

(71) Applicant: Dell Products L.P., Round Rock, TX (US)

(72) Inventors: Ahmed Khalid, Cork (IE); Stephen J. Todd, North Andover, MA (US); Alan Barnett, Co. Cork (IE); Aidan O’Mahony, Cork (IE)

(21) Appl. No.: 18/421,863

(22) Filed: Jan. 24, 2024

(51) Int. Cl. G06Q 50/06

(52) U.S. Cl. CPC G06Q 50/06; G06Q 30/0282

(57) ABSTRACT

One example method includes monitoring, by a data confidence fabric (DCF), an energy generator/provider (EGP) to determine whether the EGP is meeting its obligation to provide energy, according to terms of a service level agreement (SLA), to a customer that has executed a smart contract with the EGP, when the DCF determines that the EGP is not meeting the obligation, and depending upon a reason for the EGP failing to do so, lowering, by the DCF, a confidence score of the EGP to generate a reduced confidence score, and recording the reduced confidence score in an immutable ledger.

### FIELD OF THE INVENTION

Embodiments of the present invention generally relate to the use of confidence scores in the context of services that include providing energy to customers. More particularly, one embodiment of the invention relates to systems, hardware, software, computer-readable media, and methods, for monitoring the performance of energy providers and using information gathered during the monitoring to inform distribution of energy to customers.

### BACKGROUND

Mechanisms such as power purchase agreements (PPAs) and energy service agreements (ESAs), provide a manual approach to energy providers for subcontracting energy supply. However, these mechanisms are difficult to automate in a dynamic, real-time, granular environment. Further, compliance with regulations, SLAs (service level agreements), and provider ratings are concepts that exist in the current business standards. However, current implementations are limited in transparency and fairness. That is, in a dynamic energy marketplace where providers generate energy and deliver it to consumers, there are presently no known mechanisms for tracking the performance of providers and rating those providers in a fair, accurate, and trustworthy manner. While consumers may be able to manually share reviews, this approach can introduce bias, and other problems, and may thus lead to unreliable energy provider ratings.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture according to one embodiment.

FIG. 2 discloses aspects of a method according to one embodiment.

FIG. 3 discloses aspects of an example computing entity configured and operable to perform any of the disclosed methods, processes, and operations.

### DETAILED DESCRIPTION OF SOME EXAMPLE EMBODIMENTS

Embodiments of the present invention generally relate to the use of confidence scores in the context of services that include providing energy to customers. More particularly, one embodiment of the invention relates to systems, hardware, software, computer-readable media, and methods, for monitoring the performance of energy providers and using information gathered during the monitoring to inform distribution of energy to customers.

One example embodiment comprises a method, which may be performed in whole or in part within a DCF (data confidence fabric). In an embodiment, the method may comprise the following operations: monitoring energy output by a provider; monitoring energy provided by the provider to a customer, and the amount of energy provided is specified in a smart contract signed by the customer; determining compliance of the provider behavior with requirements of an SLA; generating and storing confidence information concerning the provider, and the confidence information is accessible by actual and prospective customers; and, automatically switching a provider to another provider based in part on the confidence information and/or SLA compliance.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that the performance of an energy provider may be evaluated using objective criteria. An embodiment may enable a customer to access objective information, which may be stored in an immutable ledger, concerning performance of an energy provider. An embodiment may automatically switch, possibly transparently to the customer, a customer from one energy provider to another energy provider based on SLA compliance of the energy provider and/or based on objective information concerning energy provider performance. An embodiment may provide a mechanism to incentivize an energy provider to improve its performance relative to one or more competitors. Various other advantages of one or more embodiments will be apparent from this disclosure.

### A. Aspects of an Example Architecture

The following is a discussion of aspects of an architecture according to one example embodiment. This discussion is not intended to limit the scope of the invention, or the applicability of any embodiment, in any way.

It is noted that the disclosure herein makes reference to an ‘SLA’ (service level agreement) and to a ‘smart contract.’ In general, the SLA comprises terms that memorialize an agreement between parties, such as an energy generator/provider and a customer, for example. The smart contract refers to the technology used to capture and implement the terms of the SLA. For example, a smart contract may smart contract may comprise computer code, an algorithm, software, or other technology which, when executed, may perform various functions and operations concerning the terms specified in the SLA. Such functions and operations may include, but are not limited to, executing, controlling, and/or documenting, one or more actions according to the terms of the SLA (see, e.g.,/en.wikipedia.org/wiki/Smart_contract). Thus, the use herein of ‘SLA terms’ refers to SLA terms implemented by way of a smart contract. Herein, the combination comprising [1] the terms of the SLA, and [2] the implementing technology of the smart contract, may be referred to as an ‘SLA smart contract’ or ‘SLASC.’

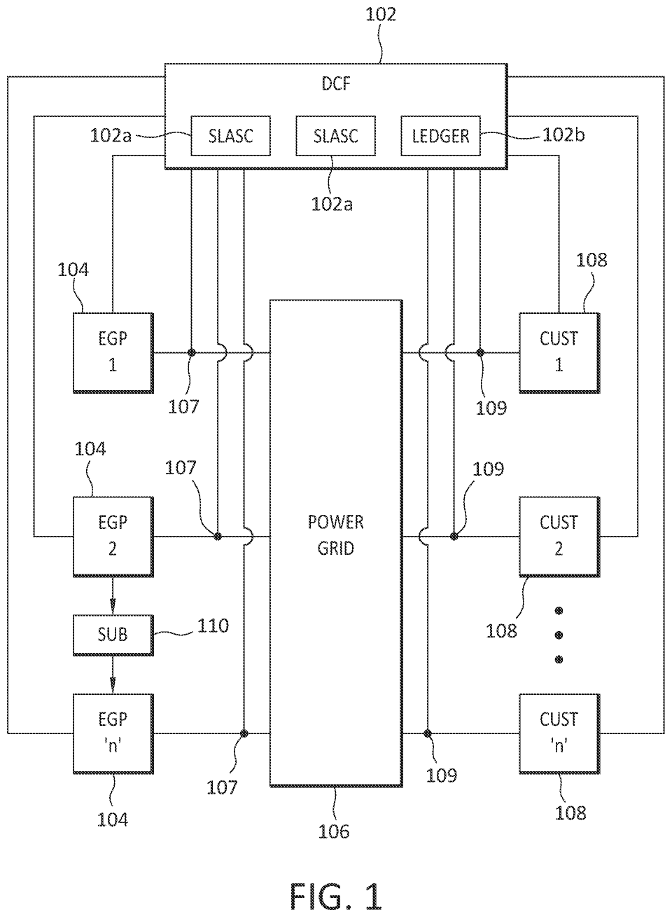

With attention now to FIG. 1, an example architecture according to one embodiment is denoted generally at 100. The architecture 100 may comprise a DCF (data confidence fabric) 102. As well, various energy generators/providers (EGP) 104 may generate and/or provide energy to, in one embodiment, a power grid 106 which may comprise a national or local power grid, for example, and the power grid 106 may, in turn, transmit the energy received from the energy generators/providers 104 to one or more customers 108.

No particular energy generator/provider 104, or energy source, is necessarily required for any embodiment. Energy generated and/or provided by an energy generator/provider 104 may be generated in various ways and by various sources including, but not limited to, wind generators, solar panels, nuclear power plants, hydroelectric systems, coal fired generation plants, and other fossil-fuel powered electrical generation plants. It is noted that while reference is made herein to the particular example of electrical power, the scope of the invention is not so limited and, rather, extends more broadly to any type of energy or energy source that is amenable to distribution, such as through some type of network or infrastructure, to customers, where one example of such an energy source or type is natural gas.

It is noted that the ‘EGP’ is so designated because an entity may be an energy generator, and may contract with an energy provider to serve customers. As well, an entity may be an energy provider, but not an energy generator, and may contract with an energy generator to serve customers. Finally, an entity may be both an energy generator, and an energy provider, and, in this respect at least, may thus be vertically integrated.

With continued reference to the example architecture 100, the DCF 102 may monitor energy output by each of the EGPs 104. As such, a respective connection 107 between an EGP 104 and the power grid 106 may comprise a node of the DCF 102.

Parameters such as, but not limited to, the amount, type, and the timing of the provision, of the energy supplied by an EGP 104 may be governed by the terms of an SLA, such as may be included in the SLASC 102a, that may be held at the DCF 102. That is, in an embodiment, both the terms of the SLA, and the corresponding implementing smart contract, may be held at the DCF 102. In an embodiment, a respective SLASC 102a may be employed for each of the EGPs 104. In this way, the DCF 102 may be able to objectively determine, on an individual EGP 104 basis, and with respect to each of the aforementioned parameters, the energy supplied by the EGPs 104 to the power grid 106.

The power grid 106 may then receive the energy generated by the EGPs 104 and supply that energy to one or more of the customers 108. The DCF 102 may monitor energy output from the power grid 106 to the customers 108. As such, a respective connection 109 between the power grid 106 and each of the customers 108 may comprise a node of the DCF 102. The amount, type, and timing, of energy received by the customers 108 may be specified in a respective smart contract, which implements terms of an SLA, signed by each of the customers 108. In an embodiment, the respective SLAs of the SLASCs 102a may be stored in an immutable ledger 102c of, or associated with, the DCF 102. In an embodiment, the respective SLA terms of the SLASCs 102a may be stored in a database accessible, using read/write access, by the DCF 102.

Among other things, the nodes 107 and 109 may collectively enable the DCF 102 to determine whether or not a customer 108 is receiving the contracted amount of energy, as specified in the SLASC 102a, from a particular EGP, or EGPs, 104 with whom the customer 108 has contracted. For example, the DCF 102 may determine, by way of one of the nodes 107 that the EGP 104 is, in fact, providing the contracted amount of energy. Thus, if monitoring of one of the nodes 109 reveals that, nonetheless, the customer 108 is not receiving the contracted amount of energy, then it may be concluded that a problem is present in the electrical power grid 106, and there is no fault with the contracting EGP 104. In this example, a confidence score of that EGP 104 would not be affected by the failure of the customer 108 to receive the amount of energy specified in the smart contract. Likewise however, if the monitoring of the node 107 reveals that the EGP 104 is failing to provide the contracted amount of energy, a confidence score of the EGP 104 may be reduced accordingly, and the customer 108 that was to receive that energy may be automatically switched to another EGP 104, possibly without the customer 108 being made aware of the switch. In either of these example scenarios, the confidence information concerning the EGP 104 may be stored in the immutable ledger 102c and may be read out by actual and prospective customers 108 for use in making a decision as to which EGP 104 to contract with. Further discussion of confidence information and smart contracts is provided below.

### B. Discussion of Aspects of an Example Embodiment

In an embodiment, the DCF 102 may collect, such as by way of the nodes 107 and 109, granular metadata indicating, among other things, an amount and/or timing of energy production by the EGP 104 and an amount, and/or timing, of energy received, and/or consumed by, a customer 108. This metadata may be used to accurately track whether an EGP 104 met the obligation(s) specified in the SLA of its SLASC 102a and delivered on its promises. In an embodiment, a confidence score of an EGP 104 may be adjusted based on its behavior and performance, and this may, in turn, provide a competitive edge to the high-performing EGPs 104 in an energy marketplace.

An embodiment may comprise, and/or be implemented in, a DCF (102)-based energy ecosystem where smart contracts 102c are used by EGPs 104 to share the information related to source of their energy and the amount that they will generate at each timeslot. The customers 108 may sign the smart contract of the SLASC 102a and register the amount of energy they require at each timeslot. To improve efficiency, the EGPs 104 may reduce production, based on the subscribed customers 108 and requests at each timeslot, however this may lead to unmet demands due, for example, to misconfigured generators at the EGP 104. Furthermore, in some scenarios, an EGP 104 may not be able to meet the contracted demand due to various reasons, such as, but not limited to, lack of resources, faulty equipment, or down time of an energy generator due to maintenance.

Thus, integration of a power supply system with the DCF 102 may enable an embodiment to monitor and track the EGPs 104 that are known to be producing reduced amounts of energy. An embodiment may use this information to switch a customer 108 of such an EGP 104 to a load shedding mode where the customer 108 may experience blackouts or other energy shortfalls. In the example scenario, an embodiment may reduce the confidence score of the EGPs based on, for example, the unmet terms of the SLAs respectively included in the various SLASCs 102a, and downtimes. In an embodiment where such a breach of the SLA terms of the SLASC 102a occurs, a customer 108 may switch to other EGP(s) 104 by simply signing a new smart contract of a new SLASC 102a.

In an embodiment, the energy metadata, such as may be gathered by way of the nodes 107 and 109, and reports may lag a few seconds after the energy generation or transmission has taken place. This lag may result from the processing of metadata and the time to reach consensus by a distributed ledger technology (DLT), such as the immutable ledger 102c, in comparison to the speed at which electricity travels. An embodiment may use the respective confidence scores of the EGPs 104 to reactively handle malicious or misconfigured energy providers.

Using the DCF 102, and calculating confidence scores for the EGPs 104, may provide various useful results. For example, in an embodiment, a cost penalty may be applied to one or more EGPs 104 based on a respective amount of energy produced with incorrect readings, that is, whose parameters do not meet the requirements of the SLASC 102a. As another example, a confidence score may be decreased for the EGP 104, and may be reflected as a reduced rating for the EGP 104. This rating information may be accessible by new customers 108. It is noted that while, in an embodiment, consensus and data processing delays may not be able to be reduced enough to match energy production speed, using confidence scores to react to, and assess, malicious or misconfigured EGPs 104 may minimize the negative impact on an energy ecosystem, which may comprise the power grid 106, EGPs 104, and customers 108, due to such EGPs 104, and may help to maintain an overall reliability of that energy ecosystem.

To handle scheduled downtimes of an EGP 104 or its energy generation, and energy transmission, systems and equipment, such as for maintenance for example, one embodiment may provide for subcontracting for EGPs 104, as shown in FIG. 1. In general, an EGP 104 unable to meet its obligations, as provided by an SLA of the SLASC 102a, may enter into a sub-contract 110 with another EGP 104 that is able to meet those requirements.

In one embodiment, the sub-contract relation between two EGPs 104 may be achieved by delegate calls in the smart contracts 102b. In more detail, a smart contract function in the EGP 104 contract may be used to “delegate,” or forward, energy requests from a customer 108 to one or more other EGPs 104. In an embodiment, only the owner of the smart contract, that is, a contracting EGP 104, of the SLASC 102a, will be authorized to call this function. The EGP 104 may buy energy from one or more other EGPs 104, for the timeslots, specified in the smart contract 102b, for which the calling EGP 104 cannot meet the customer 108 demand. In an embodiment, the EGP 104 will pay the advertised cost and, in this way, ensure uninterrupted supply to their customers 108, while also maintaining its, the EGP 104, confidence score. That is, the confidence score of the EGP 104 that sub-contracts its obligations will not suffer as a result of the sub-contracting. Moreover, if the sub-contract EGP 104 fails to meet its obligations under the sub-contract, the confidence score of the sub-contract EGP 104, and possibly the confidence score of the contracting EGP 104 as well, may be reduced accordingly.

Following is an example scenario with the aforementioned circumstances. A comprehensive metadata collection and price guidance modules may enable energy providers to find the cheapest option that will allow them to meet all their respective SLAs 102a during downtimes. For example, a renewable energy provider that uses solar energy may be unable to meet the demands during timeslots that have unexpected cloudy or stormy weathers. If some, or all, of its customers 108 will accept any renewable energy source, the EGP 104 may buy the energy for those customers 108 from wind-based EGP(s) 104 that may have higher supply, and lower rates, during such timeslots. In an embodiment, this may be done through delegate calls in an automated, and seamless manner, which may be transparent to the customers 108, while still maintaining records and reports for accurate payment distribution and historic insights.

Thus, an embodiment may possess various useful features and advantages, although no embodiment is required to possess any of such features or advantages. The following examples are illustrative. An embodiment may use confidence scores as trustworthy fair ratings for EGPs, that may be calculated based on pre-set rules and conditions, such as may be specified by an SLA of an SLASC 102a, rather than relying on manual, inconsistently received, and possibly subjective, customer feedback for determining a rating of an EGP.

As another example, an embodiment may employ delegate function calls in smart contracts to allow dynamic sub-contracting for EGPs, enabling an EGP to continue meeting customer SLAs and high ratings during legitimate downtimes, such as may occur as a result of maintenance or resource shortages, or natural phenomena, for example. Thus, the use of delegate function calls may help to avoid, or at least attenuate, problems such as customer blackouts, brownouts, and other technical problems resulting from a partial, or total, loss of energy.

### C. Example Methods

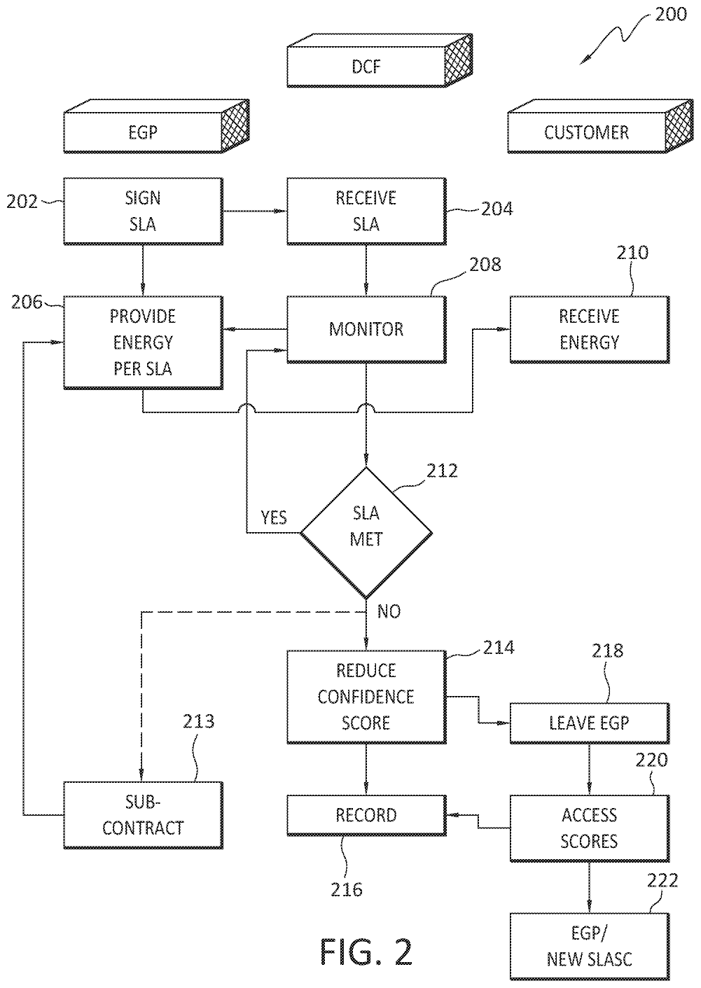

It is noted with respect to the disclosed methods, including the example method of FIG. 2, discussed below, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### C.1 Overview of Aspects of Some Example Methods

One example embodiment may comprise two elements, namely, [1] using a confidence score as a rating mechanism for an EGP, and [2] sub-contracting of energy provision obligations in the event of planned/unplanned downtime that affects the ability to meet those obligations. In an embodiment, one or more respective elements of the method may be performed by an EGP, one or more customers, and a DCF.

With regard to the first element [1], one example method may comprise the following operations: (i) an EGP signs an SLA which is held on the DCF; (ii) if the EGP is unable to meet the terms of an SLA, the confidence score of the EGP is reduced on the DCF—the failure of an EGP to meet its SLA obligations may trigger a series of actions, such as, but not limited to (a) a customer experiences a blackout as a result of not receiving enough energy, (b) the DCF monitoring catches this event, and associated impacts, and (c) the DCF reacts to the event, such as by reducing the confidence score of the EGP; (iii) the customer may leave the ‘broken’ SLA and switch to another provider so as to minimize disruptions and associated impacts on the customer operations; (iv) DCF users/customers can view an EGP confidence score—the DCF verifiable confidence score based rating mechanism enables informed customer decisions as to its energy providers.

The second element [2], may be implicated when an EGP fails to meet its SLA obligations (see ii above), and may supplement [1] (ii). Thus, the second element [2] may be implemented when an EGP fails to meet its SLA obligations and may comprise the operations: (i) in the event of downtime, enable legitimate providers to avoid reduced confidence score for genuine situations; (ii) providers can use the “delegate” function in the DCF SLA smart contract to sub-contract to another provider, thus: (a) “delegate” function communicates with another EGP smart contract/service, and (b) payment for the sub-contract is agreed between providers; (iii) the operations (a) and (b) may be seamless, and transparent, from the perspective of the affected customer(s)—for example, (a) there may be minimal or no disruption, based on the SLA, (b) the customer may be guaranteed a preferred energy type under SLA (such as solar, hydro, non-fossil fuel, or other, for example), (c) the DCF may provide visibility on sources/lineage of energy entering the grid for these guarantees, and this visibility may extend to information on sub-contractor sources, and (d) the energy lineage may full information to support compliance checks, transparency as to energy sources and networks, and auditing of EGPs.

### C.2 Aspects of an Example Method According to One Embodiment

Directing attention now to FIG. 2, a method according to one example embodiment is generally denoted at 200. Various operations of the method 200 may be respectively implemented by, and/or at the direction of, one or more EGPs, a DCF, and one or more customers. The functional allocation disclosed in FIG. 2 is provided by way of example, and is not intended to limit the scope of the invention in any way.

The example method 200 may begin when an EGP signs 202 an SLA, which may or may not have been provided by the DCF. The signed SLA may be received 204 by the DCF from the EGP. At the same time, a customer may sign 206 a smart contract, which may be received 208 by the DCF from the customer. Upon execution of the smart contract, the EGP may provide energy 206 per the terms of the SLA and, correspondingly, the customer may begin to receive 210 the energy provided by the EGP.

When the EGP has begun providing energy 206, the DCF may commence monitoring 208 a node by way of which the EGP provides energy to a recipient such as an electrical power grid. The monitoring 208 may result in the gathering of information indicating, but not limited to, the amount, type, and timing, of energy provided by the EGP to the electrical power grid. Additionally, or alternatively, the DCF may monitor 208 the amount, type, and timing, of energy received by the customer that entered the smart contract with the EGP.

The information gathered as a result of the monitoring 210 may be used to perform a check 212 to determine if the EGP is meeting its SLA obligations. If the EGP is determined 212 by the DCF to be meeting its SLA obligations, the method 200 may return to 208. On the other hand, if it is determined 212 that the EGP is not meeting its SLA obligations, the method 200 may proceed to 214 where the DCF correspondingly reduces a confidence score of the EGP. The reduced confidence score may be recorded 216, such as in an immutable ledger of the DCF.

In an embodiment, the reduction of the confidence score may result in, or enable, the customer leaving 218 the smart contract of the EGP that failed to meet the requirements. The confidence scores of the EGPs may be accessible 220 by both actual and prospective customers, and a decision of a customer to leave 218 a smart contract, and move 222 to a new SLASC, may be based on customer awareness of the reduced confidence score. In an embodiment, a customer may perform its own monitoring process, possibly alongside that of the DCF, to determine if the EGP is meeting its smart contract obligations to the customer. In an embodiment, a customer need not access 220 confidence scores, nor initiate a move 222 to another EGP or SLASC. Rather, the DCF may automatically move 222 the customer to another EGP if the determination 212 is made that the EGP is not meeting its SLA obligations.

As noted elsewhere herein, there may, or may not, may be a legitimate reason or reasons for the failure of an EGP to meet its SLA obligations. Where such legitimate reasons are determined, such as by the DCF, to exist, the confidence score reduction 214 may be omitted, at least so long as the EGP timely sub-contracts 213 its obligations under the SLA to another EGP. The new EGP may have its performance monitored 210 by the DCF as described above.

In an embodiment, a legitimate reason or reasons may be determined automatically or programmatically, possibly by the DCF. In an embodiment, a legitimate reason or reasons may be determined and manually entered by a user, such as by way of a UI for example. One embodiment may employ one or more programmatically determined legitimate reasons, and one or more legitimate reasons entered by a user.

### D. Further Example Embodiments

Following are some further example embodiments of the invention. These are presented only by way of example and are not intended to limit the scope of the invention in any way.

Embodiment 1. A method, comprising: monitoring, by a data confidence fabric (DCF), an energy generator/provider (EGP) to determine whether the EGP is meeting its obligation to provide energy, according to terms of a service level agreement (SLA), to a customer that has executed a smart contract with the EGP; when the DCF determines that the EGP is not meeting the obligation, and depending upon a reason for the EGP failing to do so, lowering, by the DCF, a confidence score of the EGP to generate a reduced confidence score; and recording the reduced confidence score in an immutable ledger.

Embodiment 2. The method as recited in any preceding embodiment, wherein the monitoring comprises monitoring, at a first node of the DCF, energy provided by the EGP, and monitoring, at a second node of the DCF, energy received by the customer from the EGP.

Embodiment 3. The method as recited in any preceding embodiment, wherein the confidence score is readable by actual, and prospective, customers of the EGP.

Embodiment 4. The method as recited in any preceding embodiment, wherein the SLA is held at the DCF.

Embodiment 5. The method as recited in any preceding embodiment, wherein the energy comprises electrical power.

Embodiment 6. The method as recited in any preceding embodiment, wherein when the DCF determines that the EGP is not meeting the obligation, the customer is automatically switched to a new EGP to receive energy from the new EGP.

Embodiment 7. The method as recited in any preceding embodiment, wherein when the reason that the EGP is not meeting the obligation is an unexpected circumstance, the confidence score of the EGP is not lowered.

Embodiment 8. The method as recited in embodiment 7, wherein a delegate call of the smart contract is usable to subcontract the obligation to another EGP.

Embodiment 9. The method as recited in any preceding embodiment, wherein the confidence score is accessible by a prospective customer, and usable by the prospective customer to select an energy provider.

Embodiment 10. The method as recited in any preceding embodiment, wherein the monitoring comprises collecting, by the DCF, metadata indicating a source type, and lineage, of the energy provided by the EGP.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

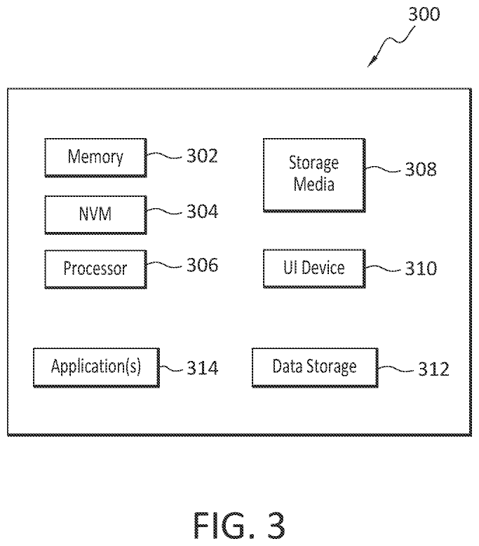

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
monitoring, by a data confidence fabric (DCF), an energy generator/provider (EGP) to determine whether the EGP is meeting its obligation to provide energy, according to terms of a service level agreement (SLA), to a customer that has executed a smart contract with the EGP;
when the DCF determines that the EGP is not meeting the obligation, and depending upon a reason for the EGP failing to do so, lowering, by the DCF, a confidence score of the EGP to generate a reduced confidence score; and
recording the reduced confidence score in an immutable ledger.

2. The method as recited in claim 1, wherein the monitoring comprises monitoring, at a first node of the DCF, energy provided by the EGP, and monitoring, at a second node of the DCF, energy received by the customer from the EGP.

3. The method as recited in claim 1, wherein the confidence score is readable by actual, and prospective, customers of the EGP.

4. The method as recited in claim 1, wherein the SLA is held at the DCF.

5. The method as recited in claim 1, wherein the energy comprises electrical power.

6. The method as recited in claim 1, wherein when the DCF determines that the EGP is not meeting the obligation, the customer is automatically switched to a new EGP to receive energy from the new EGP.

7. The method as recited in claim 1, wherein when the reason that the EGP is not meeting the obligation is an unexpected circumstance, the confidence score of the EGP is not lowered.

8. The method as recited in claim 7, wherein a delegate call of the smart contract is usable to subcontract the obligation to another EGP.

9. The method as recited in claim 1, wherein the confidence score is accessible by a prospective customer, and usable by the prospective customer to select an energy provider.

10. The method as recited in claim 1, wherein the monitoring comprises collecting, by the DCF, metadata indicating a source type, and lineage, of the energy provided by the EGP.

11. A non-transitory storage medium having stored therein instructions that are executable by one or more hardware processors to perform operations comprising:
monitoring, by a data confidence fabric (DCF), an energy generator/provider (EGP) to determine whether the EGP is meeting its obligation to provide energy, according to terms of a service level agreement (SLA), to a customer that has executed a smart contract with the EGP;
when the DCF determines that the EGP is not meeting the obligation, and depending upon a reason for the EGP failing to do so, lowering, by the DCF, a confidence score of the EGP to generate a reduced confidence score; and
recording the reduced confidence score in an immutable ledger.

12. The non-transitory storage medium as recited in claim 11, wherein the monitoring comprises monitoring, at a first node of the DCF, energy provided by the EGP, and monitoring, at a second node of the DCF, energy received by the customer from the EGP.

13. The non-transitory storage medium as recited in claim 11, wherein the confidence score is readable by actual, and prospective, customers of the EGP.

14. The non-transitory storage medium as recited in claim 11, wherein the SLA is held at the DCF.

15. The non-transitory storage medium as recited in claim 11, wherein the energy comprises electrical power.

16. The non-transitory storage medium as recited in claim 11, wherein when the DCF determines that the EGP is not meeting the obligation, the customer is automatically switched to a new EGP to receive energy from the new EGP.

17. The non-transitory storage medium as recited in claim 11, wherein when the reason that the EGP is not meeting the obligation is an unexpected circumstance, the confidence score of the EGP is not lowered.

18. The non-transitory storage medium as recited in claim 17, wherein a delegate call of the smart contract is usable to subcontract the obligation to another EGP.

19. The non-transitory storage medium as recited in claim 11, wherein the confidence score is accessible by a prospective customer, and usable by the prospective customer to select an energy provider.

20. The non-transitory storage medium as recited in claim 11, wherein the monitoring comprises collecting, by the DCF, metadata indicating a source type, and lineage, of the energy provided by the EGP.
